(19) United States
(12) Patent Application Publication
(10) Pub. No.: US 2023/0273815 A1
(43) Pub. Date: Aug. 31, 2023

(54) Method For Controlling Data Flow

(71) Applicant: TMAXSOFT CO., LTD, Gyeonggi-do (KR)

(72) Inventors: Seogyun KIM, Gyeonggi-do (KR); Byungkwan JU, Gwangju (KR)

(73) Assignee: TMAXSOFT CO., LTD, Gyeonggi-do (KR)

(21) Appl. No.: 17/719,788

(22) Filed: Apr. 13, 2022

(30) Foreign Application Priority Data
Jan. 28, 2022 (KR) 10-2022-0012823

(51) Int. Cl. G06F 9/48

(52) U.S. Cl. CPC G06F 9/4881

(57) ABSTRACT

An exemplary embodiment of the present disclosure provides a method of controlling a flow of data, the method being performed by an encoder of a computing device including a processor, a memory, and the encoder, the method including: receiving a plurality of data from the memory; determining a priority for the plurality of data; and transmitting the plurality of data to the processor based on the priority.

### CROSS-REFERENCE TO RELATED APPLICATIONS

This application claims priority to and the benefit of Korean Patent Application No. 10-2022-0012823 filed in the Korean Intellectual Property Office on Jan. 28, 2022, the entire contents of which are incorporated herein by reference.

### TECHNICAL FIELD

The present disclosure relates to processing of data, and more particularly, to a method of controlling data flow between a processor and a memory.

### BACKGROUND ART

In general, a computing device includes a processor performing data processing and a memory storing data generated within the computing device.

The processor may include a central processing device for performing processing of various data generated within the computing device.

The memory may include a Processing-In-Memory (PIM) to have a fast response speed and a fast operation speed to the processor. The intelligent memory semiconductor is a semiconductor including a processor function capable of performing operation in the memory. Therefore, the PIM may process data within the memory.

The processor and the memory are connected to each other so that data can be moved. Therefore, the processor may perform processing on a series of data generated in the memory. When there is a plurality of data to be processed, the processor may process the data by allocating tasks in order.

### PRIOR ART LITERATURE

### Patent Document

Korean Patent No. 10-0582033 (May 15, 2006)

### SUMMARY OF THE INVENTION

The present disclosure has been conceived in response to the foregoing background art, and has been made in an effort to control data flow between a processor and a memory.

The technical objects of the present disclosure are not limited to the foregoing technical objects, and other non-mentioned technical objects will be clearly understood by those skilled in the art from the description below.

An exemplary embodiment of the present disclosure discloses a method of controlling a flow of data, the method being performed by an encoder of a computing device including a processor, a memory, and the encoder, the method including: receiving a plurality of data from the memory; determining a priority for the plurality of data; and transmitting the plurality of data to the processor based on the priority.

Alternatively, the memory may include a plurality of different processing-in-memories (PIMs), and the plurality of PIMs may generate the plurality of data including data related to operation processing performed in each of the plurality of PIMs.

Alternatively, the priority may be determined so that the data has a higher priority when a response speed of the plurality of PIMs corresponding respectively to the plurality of data, is faster.

Alternatively, the priority may be determined so that the data has a higher priority when a size of data included in each of the plurality of data is smaller.

Alternatively, the determining of the priority for the plurality of data may include: generating a plurality of masking data through masking each of the plurality of data; and determining the priority based on the plurality of masking data.

Alternatively, the plurality of masking data may be characterized in that a first part of each of the plurality of data that is not related to operation processing is masked, and a remaining part except for the first part is not masked.

Alternatively, the priority may be determined so that the data has a higher priority when a size of the remaining parts of each of the plurality of data, except for the first part, is smaller.

Alternatively, the priority may be determined so that the data has a higher priority when an amount of data related to the operation processing included in each of the plurality of data is smaller.

Alternatively, the determining of the priority for the plurality of data may include determining the priority for the plurality of data at a time point at which processing of previous data is completed in the processor.

Alternatively, the method may include: receiving at least one new data from the memory after the determining of the priority for the plurality of data; and re-determining priorities for the plurality of data and said at least one new data.

Another exemplary embodiment of the present disclosure provides a non-transitory computer readable medium including a computer program, wherein the computer program includes commands for causing an encoder of a computing device to perform following operations to control a flow of data, the operations including: receiving a plurality of data from a memory; determining a priority for the plurality of data; and transmitting the plurality of data to the processor based on a priority.

Still another exemplary embodiment of the present disclosure provides a computing device for controlling a flow of data, the computing device including: a processor; a memory; and an encoder configured to connect the processor and the memory, in which wherein the encoder receives a plurality of data from the memory, determines a priority for the plurality of data, and transmits the plurality of data to the processor based on the priority.

The present disclosure may control the flow of data between the processor and the memory to facilitate data processing.

The effects of the present disclosure are not limited to the foregoing effects, and other non-mentioned effects will be clearly understood by those skilled in the art from the description below.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters is suggested in order to provide general understanding of one or more aspects. However, it is apparent that the aspect(s) may be carried out without the specific and detailed matters.

FIG. 1 is a diagram illustrating a computing device for controlling a flow of data according to exemplary embodiments of the present disclosure.

FIG. 2 is a diagram illustrating a method of controlling a data flow performed in the computing device according to exemplary embodiments of the present disclosure.

FIG. 3 is a simple and general schematic diagram illustrating an example of a computing environment in which exemplary embodiments of the present disclosure are implementable.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

A term “or” intends to mean comprehensive “or” not exclusive “or”. That is, unless otherwise specified or when it is unclear in context, “X uses A or B” intends to mean one of the natural comprehensive substitutions. That is, when X uses A, X uses B, or X uses both A and B, or “X uses A or B” may be applied to any one among the cases. Further, a term “and/or” used in the present specification shall be understood to designate and include all of the possible combinations of one or more items among the listed relevant items.

It should be understood that a term “include” and/or “including” means that a corresponding characteristic and/or a constituent element exists. Further, a term “include” and/or “including” means that a corresponding characteristic and/or a constituent element exists, but it shall be understood that the existence or an addition of one or more other characteristics, constituent elements, and/or a group thereof is not excluded. Further, unless otherwise specified or when it is unclear in context that a single form is indicated, the singular shall be construed to generally mean “one or more” in the present specification and the claims.

The term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

A computing device 100 according to exemplary embodiments of the present disclosure may be a predetermined type of device controlling a flow of data. For example, the computing device 100 may be a device for controlling a flow of data performed by an encoder. The computing device 100 may include a predetermined type of server or a user terminal.

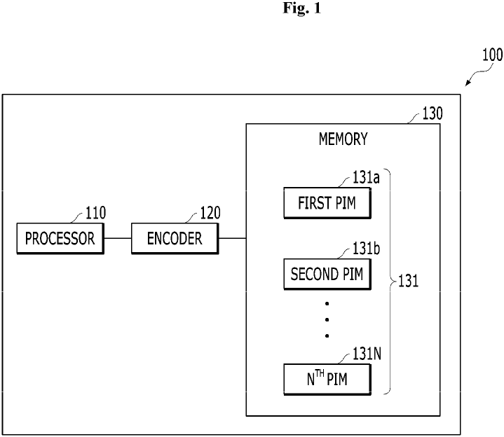

FIG. 1 is a diagram illustrating a computing device for controlling a flow of data according to exemplary embodiments of the present disclosure.

The configuration of a computing device 100 illustrated in FIG. 1 is merely a simplified example. In the exemplary embodiment of the present disclosure, the computing device 100 may include other configurations for performing a computing environment of the computing device 100, and only some of the disclosed configurations may also configure the computing device 100.

The computing device 100 may include a processor 110, an encoder 120, and a memory 130. The processor 110, the encoder 120, and the memory 130 may be connected with each other in a predetermined structure (for example, a parallel structure) through a bus. The bus may be a passage through which data, signals, information, and the like generated in the processor 110, the encoder 120, and the memory 130 or stored move. According to other exemplary embodiments of the present disclosure, the encoder 120 may also be configured to be included in a data bus.

The processor 110 may consist of one or more cores, and may include a processor, such as a Central Processing Unit (CPU), a General Purpose Graphics Processing Unit (GPGPU), and a Tensor Processing Unit (TPU) of the computing device 100, for performing an operation related to data processing.

The processor 110 may generally control the overall operation of the computing device 100. The processor 110 may provide a user with appropriate information or function or process appropriate information or function by processing signals, data, information, and the like input or output through the constituent elements included in the computing device 100 or driving an application program stored in the memory 130.

The processor 110 may control at least a part of the constituent elements of the computing device 100 in order to drive the application program stored in the memory 130. Further, the processor 110 may combine and operate at least two of the constituent elements included in the computing device 100 in order to drive the application program.

The processor 110 may receive data of the memory 130 through the encoder 120. Further, the processor 110 may transmit a command signal for data processing. The command signal for data processing may include data invert, data shift, data swap, data comparison, logical operations (for example, AND and XOR), mathematical operations (for example, addition and subtraction), and the like. Therefore, the processor 110 may transmit the command signal to the memory 130 so as to perform the processing of the received data, such as data invert, data shift, data swap, data comparison, logical operations, and mathematical operations.

The encoder 120 may connect the processor 110 and the memory 130. For example, the encoder 120 may be provided between the processor 110 and the memory 130 to transmit and receive arbitrary data, information, signals, and the like between the processor 110 and the memory 130. According to exemplary embodiments of the present disclosure, the encoder 120 may be provided between the processor 110 and the memory 130 to only serve to transmit the data generated in the memory 130 to the processor 110. Herein, when the processor 110 transmits arbitrary data, information, signals, and the like to the memory 130, the processor 110 may directly transmit the data, information, signals, and the like to the memory 130 without going through the encoder 120.

The encoder 120 may receive the plurality of data from the memory 130. The plurality of data may include the data stored in the memory 130 or data related to the operation processing performed in the memory 130. The memory 130 may include a plurality of different processing-in-memories (PIMs) 131. The plurality of PIMs may be the semiconductor including a processor function so that the operation is possible in the memory. Therefore, the plurality of PIMs 131 may process or generate the data within the memory 130. For example, the plurality of PIMs 131 may generate a plurality of data including data related to operation processing performed in each of the plurality of PIMs.

The encoder 120 may determine a priority for the plurality of data received from the memory 130. The priority may be determined based on a response speed of the plurality of PIMs 131 corresponding to the plurality of data, respectively. For example, the priority may be determined so that the data has a higher priority as the response speed of the plurality of PIMs 131 corresponding to the plurality of data, respectively, increases. Therefore, the encoder 120 may determine the priority for the plurality of data so that the data has a higher priority as the response speed of the plurality of PIMs 131 corresponding to the plurality of data, respectively, increases. The priority for the plurality of data may be an index indicating which data to be processed preferentially when data is processed. For example, the priority for the plurality of data may be the index indicating what data is preferentially transmitted to the processor 110 in order to facilitate the flow of data. Therefore, the encoder 120 may first transmit the data to be processed preferentially to the processor 110 according to the priority of the plurality of data. For example, when the priority of data A is higher than the priority of data B in the situation where there are data A and data B, the encoder 120 may first transmit data A to the processor 110 so that data A is processed before data B.

According to other exemplary embodiments of the present disclosure, the priority may be determined based on whether the plurality of PIMs 131 corresponding to the plurality of data, respectively, is an idle state. For example, the priority may be determined so that the PIM in the idle state among the plurality of PIMs 131 corresponding to the plurality of data, respectively, has a higher priority. Therefore, the encoder 120 may determine the priority for the plurality of data so that the PIM in the idle state among the plurality of PIMs 131 corresponding to the plurality of data, respectively, has a higher priority. The idle state may be a state in which a current task is completed and not being used. For example, the idle state may be state waiting for a command to initiate a task.

According to other exemplary embodiments of the present disclosure, the priority may be determined based on a size of data included in each of the plurality of data. For example, the priority may be determined so that the data has a higher priority as the size of the data included in each of the plurality of data is small. Therefore, the encoder 120 may determine the priority for the plurality of data so that the data has a higher priority as the size of the data included in each of the plurality of data is small.

In the meantime, the encoder 120 may generate a plurality of masking data through masking each of the plurality of data. The plurality of masking data may be data in which a part of each of the plurality of data is masked.

For example, the plurality of masking data is characterized in that a first part that is not related with the operation processing in each of the plurality of data is masked, and the remaining parts, except for the first part, are not masked. Accordingly, the encoder 120 may generate the plurality of masking data characterized in that the first part that is not related with the operation processing in each of the plurality of data is masked, and the remaining parts, except for the first part, are not masked.

For another example, the plurality of masking data is characterized in that a second part output from a specific input/output pin of the specific channel of each of the plurality of data is masked, and the remaining parts, except for the second part, are not masked. The data output from the specific input/output pin of the specific channel may be the unnecessary part in the case where the processor 110 processes the data. The specific input/output pin of the specific channel in which the masking is performed may be determined in advance. The specific input/output pin of the specific channel in which the masking is performed may be differently determined according to the type of data. The encoder 120 may determine the priority based on the plurality of masking data. The priority may be determined based on the size of the remaining parts, except for the first part of each of the plurality of data. For example, the priority may be determined so that the data has a higher priority as the size for the remaining parts, except the first part of each of the plurality of data, is small. Therefore, the encoder 120 may determine the priority for the plurality of data so that the data has a higher priority as the size for the remaining parts, except the first part of each of the plurality of data, is small.

According to other exemplary embodiments of the present disclosure, the priority may be determined based on the amount of data for the processing of the data included in each of the plurality of data.

For example, the priority may be determined based on the amount of data for the operation processing included in each of the plurality of data. The priority may be determined so that the data has a higher priority as the amount of data for the operation processing (for example, processing of logical operations, and processing of mathematical operations) included in each of the plurality of data is small. Therefore, the encoder 120 may determine the priority for the plurality of data so that the data has a higher priority as the amount of data for the operation processing included in each of the plurality of data is small.

For another example, the priority may be determined so that the data has a higher priority as the amount of data related to at least one of data invert, data shift, data swap, and data comparison included in each of the plurality of data is small. Therefore, the encoder 120 may determine the priority for the plurality of data so that the data has a higher priority as the amount of data related to at least one of data invert, data shift, data swap, and data comparison included in each of the plurality of data is small.

In the meantime, the encoder 120 may receive at least one new data from the memory 130 after determining the priority for the plurality of data. The encoder 120 may re-determine priorities for the plurality of data and at least one new data.

In particular, the encoder 120 may continuously receive at least one new data from the memory 130. Therefore, the encoder 120 may re-determine the priority through a comparison between at least one new data and the plurality of existing data in order to assign the priority for at least one new data.

The priority may be re-determined based on the response speed of the plurality of PIMs 131 corresponding to the plurality of data and at least one new data, respectively. For example, the priority may be re-determined so that the data has a higher priority as the response speed of the plurality of PIMs 131 corresponding to the plurality of data and at least one new data, respectively, is fast. Therefore, the encoder 120 may re-determine the priorities for the plurality of data and at least one new data so that the data has a higher priority as the response speed of the plurality of PIMs 131 corresponding to the plurality of data and at least one new data, respectively, is fast.

According to other exemplary embodiments of the present disclosure, the priority may be re-determined based on whether the plurality of PIMs 131 corresponding to the plurality of data and at least one new data, respectively, are in an idle state. For example, the priority may be determined so that the PIM in the idle state among the plurality of PIMs 131 corresponding to the plurality of data and at least one new data, respectively, has a higher priority. Therefore, the encoder 120 may determine the priorities for the plurality of data and at least one new data so that the PIM in the idle state among the plurality of PIMs 131 corresponding to the plurality of data and at least one new data, respectively, has a higher priority.

According to other exemplary embodiments of the present disclosure, the priority may be determined based on a size of the data included in each of the plurality of data and at least one new data. For example, the priority may be determined so that the data has a higher priority as a size of data included in each of the plurality of data and at least one new data is small. Therefore, the encoder 120 may determine the priorities for the plurality of data and at least one new data so that the PIM has a higher priority as a size of data included in each of the plurality of data and at least one new data is small.

In the meantime, the encoder 120 may generate at least one new masking data through masking at least one new data. At least one new masking data may be masked data in which a part of at least one new data is masked.

For example, at least one new masking data is characterized in that a third part that is not related to the operation processing in at least one new data is masked and the remaining parts except for the third part are not masked. Therefore, the encoder 120 may generate at least one new masking data that is characterized in that the third part that is not related to the operation processing in at least one new data is masked and the remaining parts except for the third part are not masked.

For another example, at least one new masking data is characterized in that a fourth part that is output from a specific input/output pin of a specific channel in at least one new data is masked and the remaining parts except for the fourth part are not masked. The data output from the specific input/output pin of the specific channel may be the unnecessary part in the case where the processor 110 processes the data. The specific input/output pin of the specific channel in which the masking is performed may be determined in advance. The specific input/output pin of the specific channel in which the masking is performed may be differently determined according to the type of data.

The encoder 120 may determine a priority based on the plurality of masking data and at least one new masking data. The priority may be determined based on the sizes of the remaining parts of each of the plurality of data, except for the first part, and the remaining parts of at least one new data, except for the third part. For example, the priority may be determined so that the data has a higher priority as the size of the remaining parts of each of the plurality of data, except for the first part, and the size of the remaining parts of at least one new data, except for the third part are small. Therefore, the encoder 120 may determine the priorities for the plurality of data and at least one new data so that so that the data has a higher priority as the size of the remaining parts of each of the plurality of data, except for the first part, and the size of the remaining parts of at least one new data, except for the third part, are small.

According to other exemplary embodiments of the present disclosure, the priority may be determined based on the amount of data for the processing of data included in each of the plurality of data and at least one new data.

For example, the priority may be determined based on the amount of data for the operation processing included in each of the plurality of data and at least one new data. The priority may be determined so that the data has a higher priority as the amount of data for the operation processing (for example, processing of logical operations, and processing of mathematical operations) included in each of the plurality of data and at least one new data is small. Therefore, the encoder 120 may determine the priority for the plurality of data and at least one new data so that the data has a higher priority as the amount of data for the operation processing included in each of the plurality of data and at least one new data is small.

For another example, the priority may be determined so that the data has a higher priority as the amount of data related to at least one of data invert, data shift, data swap, and data comparison included in each of the plurality of data and at least one new data is small. Therefore, the encoder 120 may determine the priorities for the plurality of data and at least one new data so that the data has a higher priority as the amount of data related to at least one of data invert, data shift, data swap, and data comparison included in each of the plurality of data and at least one new data is small.

According to exemplary embodiments of the present disclosure, the encoder 120 may perform masking for randomizing each of the plurality of data. Herein, the masking may mean making a random intermediate value generated when a plurality of data is calculated in order to prevent leakage of information necessary for an attacker. For example, the encoder 120 may perform Boolean masking and/or arithmetic masking on each of the plurality of data. The Boolean masking may be a masking technique using exclusive OR. The arithmetic masking may be a masking technique using algebraic operations, such as addition, subtraction, and multiplication. Therefore, the encoder 120 may perform encryption processing by performing masking for randomizing each of the plurality of data.

In the meantime, the encoder 120 may transmit the plurality of data to the processor 110 based on the priority. For example, the encoder 120 may transmit the plurality of data and/or at least one new data to the processor 110 based on the priority. Therefore, the processor 110 may perform encryption processing based on the received plurality of data. For example, the processor 110 may generate a command signal for the processing of the data based on the plurality of masking data, and transmit the command signal to the memory 130. Encryption processing may be performed on the command signal in the process in which the processor 110 generates the command signal including the command and transmits the command signal to the memory 130.

In the meantime, the encoder 120 may continuously receive data from the memory 130. In the encoder 120, the received data is accumulated, so that a plurality of data may exist. The encoder 120 may determine the priority for the plurality of data at a preset time point. For example, the encoder 120 may determine the priority for the plurality of data at a time point at which the processing for the previous data is completed in the processor 110. For example, the encoder 120 may determine the priority for the plurality of data according to a predetermined time (for example, 10 seconds or 20 seconds).

The memory 130 may store a predetermined type of information generated or determined by the processor 110 and a predetermined type of information received from the outside. The memory 130 may include at least one type of storage medium among a flash memory type, a hard disk type, a multimedia card micro type, a card type of memory (for example, an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disk. The computing device 100 may also be operated in relation to web storage performing a storage function of the memory 130 on the Internet. The description of the foregoing memory is merely illustrative, and the present disclosure is not limited thereto.

The memory 130 may include a plurality of different PIMs 131 (for example, a first PIM 131a, a second PIM 131b, ..., and an N^{th} PIM 131N.) The plurality of PIMs may be the semiconductor including a processor function so that the operation is possible in the memory. Therefore, the plurality of PIMs 131 may process or generate the data within the memory 130. For example, the plurality of PIMs 131 may generate a plurality of data including data related to operation processing performed in each of the plurality of PIMs.

The memory 130 may perform processing of data according to the command signal received from the processor 110. For example, each of the plurality of PIMs 131 included in the memory 130 may perform processing of data according to the command signal received from the processor 110. For example, the first PIM 131a may perform processing of data based on a command included in a first command signal received from the processor 110. Further, the second PIM 131b may perform processing of data based on a command included in a second command signal received from the processor 110.

The existing scheduling algorithm designed for the time-sharing system between the processor and the memory does not give priority to data processing, but allocates the processors sequentially in time units (time quantum/slice). Therefore, the existing scheduling algorithm does not consider information about the data, so that load balancing between the processor and the memory is not performed smoothly. The load balancing may mean ensuring that the load is equalized among the interconnected configurations.

As described above with reference to FIG. 1, the computing device 100 progresses the data processing based on the priority of the data by using the encoder 120, thereby increasing the processing rate of the processor 110 and the memory 130 and the utilization rate of the processor 110. Therefore, the computing device 100 is capable of efficiently processing data and reducing consumed power by decreasing overhead, response time, return time, and waiting time.

The computing device 100 reduces the waiting time for processing the processing sequence through the process of giving priority through the encoder 120 in the processing procedure of the processor 110 and the memory 130, thereby increasing the overall data operation speed.

The computing device 100 performs masking on the data and performs encryption processing on the masked data, thereby safety processing and managing data.

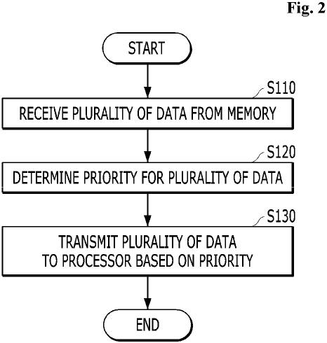

FIG. 2 is a diagram illustrating a method of controlling a data flow performed in the computing device according to exemplary embodiments of the present disclosure.

Referring to FIG. 2, the encoder 120 of the computing device 100 may receive a plurality of data from the memory 130 (S110).

The plurality of data may include the data stored in the memory 130 or data related to the operation processing performed in the memory 130. The memory 130 may include a plurality of different PIMs 131.

The encoder 120 may connect the processor 110 and the memory 130. For example, the encoder 120 may be provided between the processor 110 and the memory 130 to transmit and receive arbitrary data, information, signals, and the like between the processor 110 and the memory 130.

The encoder 120 may determine a priority for the plurality of data (S120).

The priority may be determined based on a response speed of the plurality of PIMs 131 corresponding to the plurality of data, respectively. For example, the priority may be determined so that the data has a higher priority as the response speed of the plurality of PIMs 131 corresponding to the plurality of data, respectively, increases. Therefore, the encoder 120 may determine the priority for the plurality of data so that the data has a higher priority as the response speed of the plurality of PIMs 131 corresponding to the plurality of data, respectively, increases.

According to other exemplary embodiments of the present disclosure, the priority may be determined based on whether the plurality of PIMs 131 corresponding to the plurality of data, respectively, is an idle state.

According to other exemplary embodiments of the present disclosure, the priority may be determined based on a size of data included in each of the plurality of data.

The encoder 120 may determine a priority based on the plurality of masking data. The priority may be determined based on a size of the remaining parts of each of the plurality of data, except for a first part that is not related to the operation processing. For example, the priority may be determined so that the data has a higher priority as a size of the remaining parts of each of the plurality of data, except for a first part that is not related to the operation processing, is small.

According to other exemplary embodiments of the present disclosure, the priority may be determined based on the amount of data for the processing of the data included in each of the plurality of data.

For example, the priority may be determined based on the amount of data for the operation processing included in each of the plurality of data. The priority may be determined so that the data has a higher priority as the amount of data for the operation processing (for example, processing of logical operations, and processing of mathematical operations) included in each of the plurality of data is small.

For another example, the priority may be determined so that the data has a higher priority as the amount of data related to at least one of data invert, data shift, data swap, and data comparison included in each of the plurality of data is small.

The encoder 120 may transmit the plurality of data to the processor 110 based on the priority (S130).

For example, the encoder 120 may transmit the plurality of data and/or at least one new data to the processor 110 based on the priority. Therefore, the processor 110 may perform encryption processing based on the received plurality of data. For example, the processor 110 may generate a command signal for the processing of the data based on the plurality of masking data, and transmit the command signal to the memory 130. Encryption processing may be performed on the command signal in the process in which the processor 110 generates the command signal including the command and transmits the command signal to the memory 130.

The operations illustrated in FIG. 2 are illustrative operations. Accordingly, it will also be apparent to those skilled in the art that some of the operations in FIG. 2 may be omitted or additional operations may be present without departing from the scope of the present disclosure. Further, specific details regarding the configurations described in FIG. 2 (for example, the processor 110, the encoder 120, and the memory 130 of the computing device 100) will be replaced with the contents described with reference to FIG. 1 above.

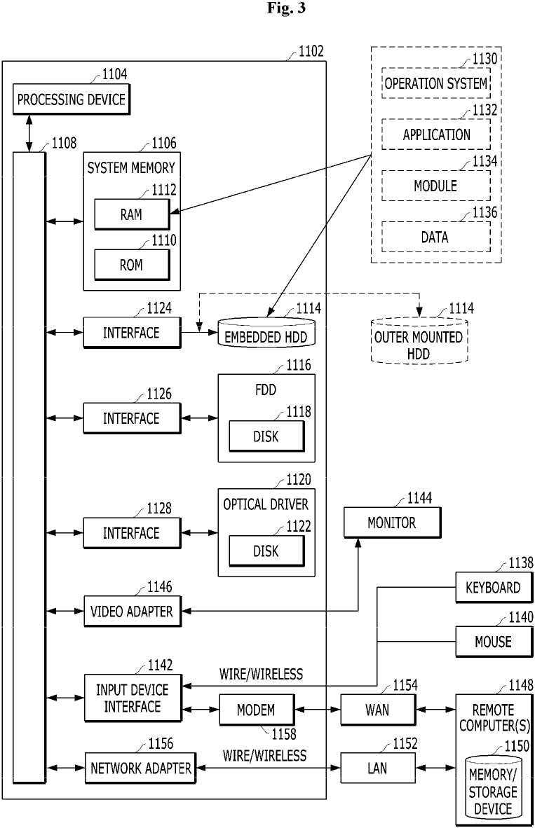

FIG. 3 is a simple and general schematic diagram illustrating an example of a computing environment in which exemplary embodiments of the present disclosure are implementable.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA)) - the embedded HDD 1114 being configured for exterior mounted usage within a proper chassis (not illustrated) - a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a predefined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

What is claimed is:

1. A method of controlling a flow of data, the method being performed by an encoder of a computing device including a processor, a memory, and the encoder, the method comprising:
receiving a plurality of data from the memory;
determining a priority for the plurality of data; and
transmitting the plurality of data to the processor based on the priority.

2. The method of claim 1, wherein the memory includes a plurality of different processing-in-memories (PIMs), and
the plurality of PIMs generate the plurality of data including data related to operation processing performed in each of the plurality of PIMs.

3. The method of claim 2, wherein the priority is determined so that the data has a higher priority when a response speed of the plurality of PIMs corresponding respectively to the plurality of data, is faster.

4. The method of claim 1, wherein the priority is determined so that the data has a higher priority when a size of data included in each of the plurality of data is smaller.

5. The method of claim 1, wherein the determining of the priority for the plurality of data includes:
generating a plurality of masking data through masking each of the plurality of data; and
determining the priority based on the plurality of masking data.

6. The method of claim 5, wherein the plurality of masking data is characterized in that a first part of each of the plurality of data that is not related to operation processing is masked, and a remaining part except for the first part is not masked.

7. The method of claim 6, wherein the priority is determined so that the data has a higher priority when a size of the remaining parts of each of the plurality of data, except for the first part, is smaller.

8. The method of claim 5, wherein the priority is determined so that the data has a higher priority when an amount of data related to the operation processing included in each of the plurality of data is smaller.

9. The method of claim 1, wherein the determining of the priority for the plurality of data includes determining the priority for the plurality of data at a time point at which processing of previous data is completed in the processor.

10. The method of claim 1, further comprising:
receiving at least one new data from the memory after the determining of the priority for the plurality of data; and
re-determining priorities for the plurality of data and said at least one new data.

11. A non-transitory computer readable medium including a computer program, wherein the computer program includes commands for causing an encoder of a computing device to perform following operations to control a flow of data, the operations comprising:
receiving a plurality of data from a memory;
determining a priority for the plurality of data; and
transmitting the plurality of data to the processor based on a priority.

12. A computing device for controlling a flow of data, the computing device comprising:
a processor;
a memory; and
an encoder configured to connect the processor and the memory,
wherein the encoder receives a plurality of data from the memory, determines a priority for the plurality of data, and transmits the plurality of data to the processor based on the priority.
